(19) United States
(12) Patent Application Publication
(10) Pub. No.: US 2026/0192865 A1
(43) Pub. Date: Jul. 9, 2026

(54) HEADBOARD TRUCK RACK

(71) Applicant: Mike Tomasek, Petaluma, CA (US)

(72) Inventor: Mike Tomasek, Petaluma, CA (US)

(21) Appl. No.: 19/406,559

(22) Filed: Dec. 2, 2025

Related U.S. Application Data
(60) Provisional application No. 63/743,078, filed on Jan. 8, 2025.

(51) Int. Cl. B62D 33/02

(52) U.S. Cl. CPC B62D 33/0207

(57) ABSTRACT

A truck bed rack header includes a plurality of cross members extending generally horizontally with left and right end members interconnecting with left and right ends, respectively, of each of the plurality of cross members. The left and right end members form at least a portion of the left and right sides of a front end of a truck bed rack assembly. The truck bed rack header may be a stand-alone unit, fitting into angled members attachable to tops of a truck bed side member, or may be a retrofit design, fitting into a rack system already present on a truck.

### CROSS-REFERENCE INFORMATION

This application claims priority to U.S. Provisional Patent Application Ser. No. 63/743,078, filed on Jan. 8, 2025, which is incorporated herein in its entirety.

### BACKGROUND OF THE INVENTION

### 1. Field of the Invention

Embodiments of the invention relate generally to racking for trucks. More particularly, embodiments of the invention relate to a headboard truck rack that can be designed as an entire unit or designed to retrofit into a truck's existing rack system.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Truck headboards have a functionality to protect the rear window of the truck cab from items stored in the bed of the truck. Typically, truck headboards are made of a heavy screen-like material, providing the desired functionality but without any aesthetic value.

In view of the foregoing, there is a need for a headboard truck rack that can be easily installed, protect the rear window of the truck cab and provide aesthetic value for the user.

### SUMMARY OF THE INVENTION

Embodiments of the present invention provide a truck headboard that can be placed on a truck without an existing rack. The truck headboard can include rails that mount to the top of the sides of the truck bed. Headboard mounting brackets can extend inward (toward the bed of the truck) at forward ends of the rails to provide a channel into which the headboard may be positioned. The length of each of the headboard mounting brackets may be from about 4 inches to about 12 inches long, permitting the headboard to fit, even if the width of the bed of the truck varies slightly from model to model.

Embodiments of the present invention provide a truck headboard that can be fit into an existing rack already present on a truck. The headboard can include end members that have fittings extending generally orthogonal therefrom to slidably engage with a central headboard member. The end members can attach to risers of the existing truck rack and the headboard can be fit, via the fittings.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a front view of a first variant of a headboard system for mounting to a truck according to an exemplary embodiment of the present invention;

FIG. 2 illustrates a detailed side view of the first variant of the headboard system of FIG. 1;

FIG. 3 illustrates a perspective, exploded view of a second variant of a headboard system for mounting to an existing rack system of a truck, according to an exemplary embodiment of the present invention;

FIG. 4 illustrates perspective view of a third variant of a headboard system installed in a truck;

FIG. 5 illustrates a front view of the third variant of the headboard system of FIG. 4; and

FIG. 6 illustrates a front view of a fourth variant of a headboard system installed in a truck.

FIG. 7 illustrates an exploded view of a fifth variant of a headboard system.

FIG. 8 illustrates an exploded view of a sixth variant of a headboard system.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

A headboard truck rack that can be easily installed, protect the rear window of the truck cab and provide aesthetic value for the user are achieved by variants of a truck bed rack header. The variants of a truck bed rack header may comprise: a plurality of cross members extending generally horizontally with left and right end members interconnecting with left and right ends, respectively, of each of the plurality of cross members. The left and right end members form at least a portion of the left and right sides of a front end of a truck bed rack assembly. The truck bed rack header may be a stand-alone unit, fitting into angled members attachable to tops of a truck bed side member, or may be a retrofit design, fitting into a rack system already present on a truck

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a truck bed rack header includes a plurality of cross members extending generally horizontally with left and right end members interconnecting with left and right ends, respectively, of each of the plurality of cross members. The left and right end members form at least a portion of the left and right sides of a front end of a truck bed rack assembly.

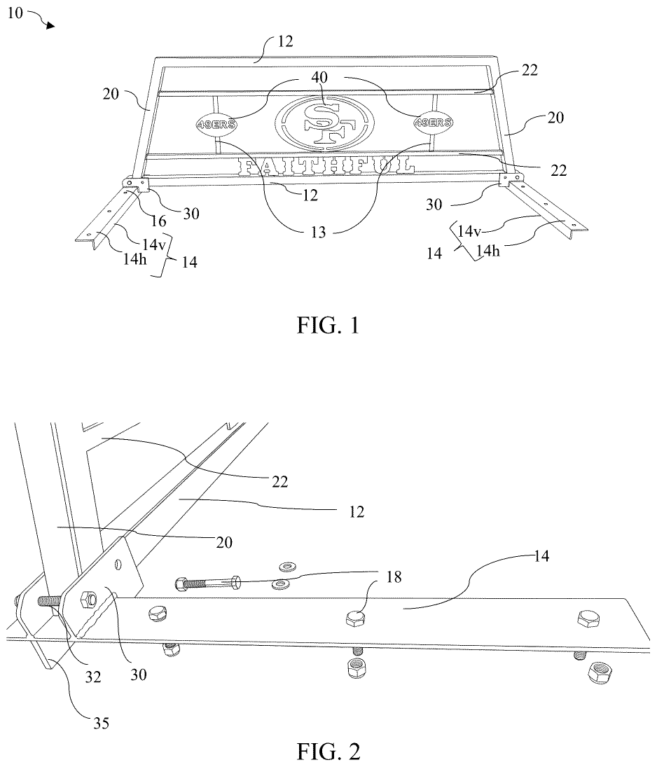

A truck bed rack header system 10 (a first variant of a truck bed rack header system, as depicted in FIG. 1 and FIG. 2) may comprise: a headboard 12 and side rails 14. The side rails 14 can include a plurality of holes 16 for bolts 18 to pass through to engage with sides of a truck (not shown). The top and bottom units of headboard 12, can fuse to the left and right units of end members to define a frame that includes a plurality of cross members 22 that span between end members 20. A design, such as an NFL football design (including a design representing any of the 32 current NFL teams), as one example, may be displayed between the end members 20, supported by the cross members 22, are contained, engraved, or carved into circular surface 40. Stanchions 13 may be vertical bars spanning from a bottom unit of the plurality of cross members 22 and a top unit of the plurality of cross members 22.

Headboard receiving channels 30 may be fixed on ends of each of the side rails 14, which can be L-shaped (i.e., horizontal component 14h and vertical component 14v contact each other to make a perpendicular operative connection). The receiving channels 30 may extend inward at each side of the truck, when the side rails 14 are installed along sides of the truck bed. The receiving channels 30 may extend from about 3 inches to about 12 inches in length. The end members 20 may fit into the receiving channels 30 to support the headboard 12 to the side rails 14. A bolt 32 may be used to tighten the channel 30 to secure the headboard 12 thereto. In some embodiments, the bolt 32 may extend through the end members 20. In other embodiments, the bolts 32 may clamp the channel 30 onto the end members 20. A unit of spacer 35 is a bottom vertical spacer that may be fused, and thereby operatively connected to each unit of side rail 14.

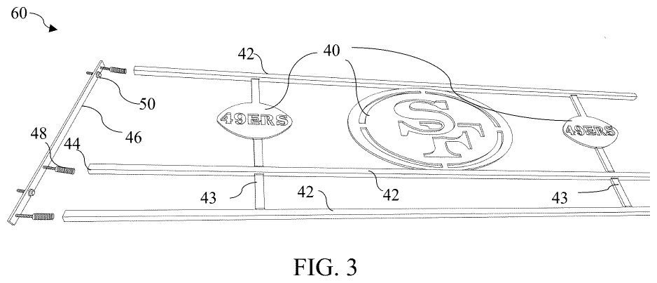

A truck bed rack header system 60 (a second variant of the truck bed rack header system, as depicted in FIG. 3) can include left and right end members 46, which have extension arms 48 that telescopingly engage with open ends 44 of each cross member of the plurality of cross members 42 of the truck bed rack header system 60. The left and right end members 46 can attach to an existing rack (not shown) on a truck via bolts 50. The length of the extension arms 48 permits the truck bed rack header system 60 to fit into an existing truck rack system, even if the dimensions vary slightly. Stanchions 43 may be vertical bars spanning through holes drilled into a bottom unit of the cross member of the plurality of cross members 42, an intermediate unit of the cross member of the plurality of cross members 42, and a top unit of the cross member of plurality of cross members 42.

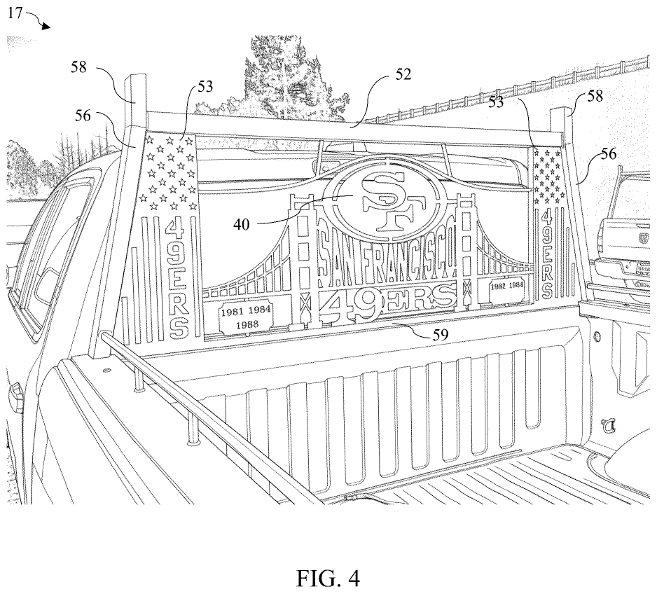

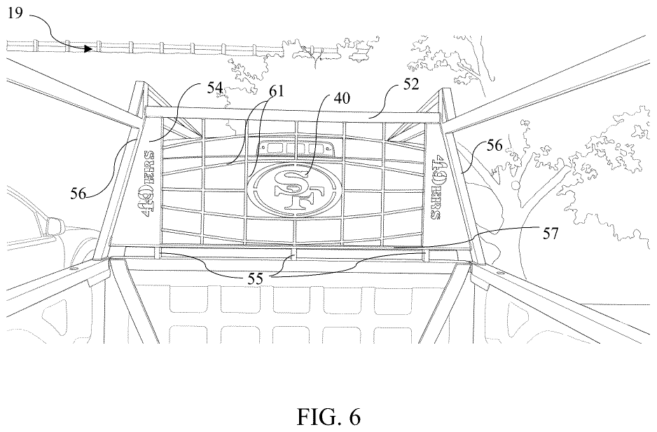

As shown in FIGS. 4 through 6, the truck bed rack header system can be used in various designs and can include additional racking, lumber stops, tie down hooks and the like.

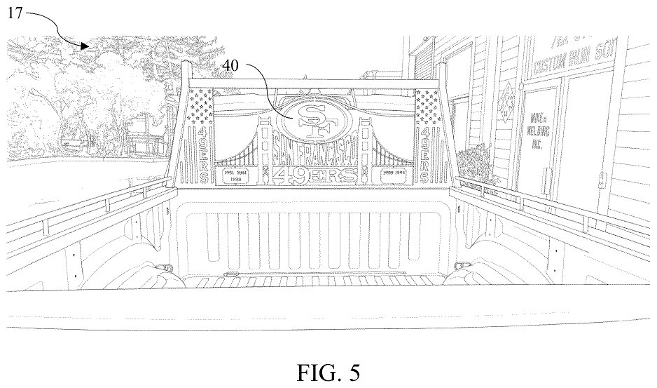

A truck bed rack header system 17 (a third variant of the truck bed rack header system depicted in in FIG. 4 and FIG. 5) may comprise: an outer frame and an inner frame. The outer frame may comprise a left and right units of side bar 56, which incline inwards towards headboard 52. Vertical spacer 58, which contacts side bar 56 and headboard 52, can emanate above headboard 52. Each unit of internal spacer 53 may be proximal, but not contacting vertical spacer 58, wherein internal spacer 53 contacts side bar 56 and headboard 52 and internal spacer 53 may be a modifiable surface for engraving patterns. The two units of internal spacer 53 may be operatively connected to each other via bottom edge 59. Bottom edge 59, an edge of the left unit of internal spacer 53, an edge of the right unit of internal spacer 53, and body of headboard 52 may define an inner frame containing a pattern which has circular surface 40.

A truck bed rack header system 19 (a fourth variant of the truck bed rack header system in FIG. 4 and FIG. 5) may comprise: an outer frame and an inner frame. The outer frame may comprise a left and right units of side bars 56, which incline inwards towards headboard 52. Each unit of internal spacer 54 may contact a unit of side bar 56 and headboard 52 and internal spacer 54 may be a modifiable surface for engraving patterns. The two units of internal spacer 54 may be operatively connected to each other via bottom edge 57. Bottom edge 57, an edge of the left unit of internal spacer 54, an edge of the right unit of internal spacer 54, and body of headboard 52 may define an inner frame containing a pattern which has circular surface 40 surrounded by cage pattern 61. There may be three units of stanchion 55, which contact a bottom most edge of the left unit of internal spacer 54, bottom edge 57, and a bottom most edge of the right unit of internal spacer 54, such that the three units of stanchion 55 further contact an edge of the truck and the inner frame is elevated in relation to said edge of the truck.

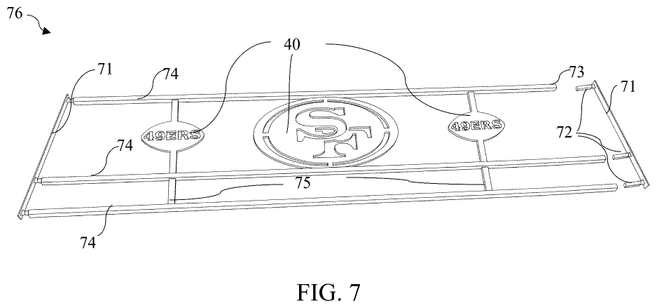

A truck bed rack header system 76 (a fifth variant of the truck bed rack header system, as depicted in FIG. 7) can include left and right end members 71, which each have, for example, three units of extending appendage 72 to make an “E”-shape to engage with open channel end 73 of each cross member of the plurality of cross members 74. Each cross member of the plurality of cross members 74 may be a hollow rectangular bar for defining a channel therein to receive extending appendage 72 through open channel end 73. The left and right end members 71 can attach to an existing rack (not shown). Stanchions 75 may be vertical bars spanning through holes drilled into a bottom unit of the cross member of the plurality of cross members 74, an intermediate unit of the cross member of the plurality of cross members 74, and a top unit of the cross member of plurality of cross members 74. Circular surface 40 may be contained within the intermediate unit of the cross member of the plurality of cross members 74, and the top unit of the cross member of the plurality of cross members 74.

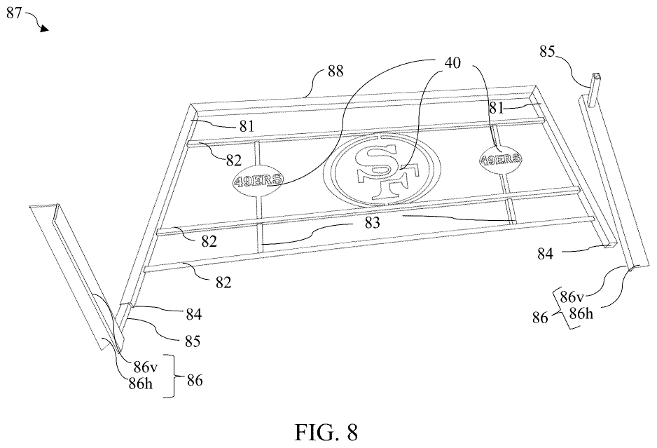

A truck bed rack header system 87 (a sixth variant of the truck bed rack header system, as depicted in FIG. 8) may comprise: left and right units of side bar 81, which incline vertically upwards towards headboard 88. Each cross member of the plurality of cross members 82 may span latitudinally from the left and right units of side bar 81. Stanchions 83 may be vertical bars spanning through holes drilled into a bottom unit of the cross member of the plurality of cross members 82, an intermediate unit of the cross member of the plurality of cross members 82, and a top unit of the cross member of plurality of cross members 82. The left and right units of side bar 81 may each be a hollow rectangular bar for defining a channel therein to receive extending appendage 85 through open channel end 84. Side rails 86 can be L-shaped (i.e., horizontal component 86h and vertical component 86v contact each other to make a perpendicular operative connection); and extending appendage 85 can be appended perpendicularly to an external surface of horizontal component 86h. Circular surface 40 may be contained within the intermediate unit of the cross member of the plurality of cross members 82, and the top unit of the cross member of the plurality of cross members 82.

While football team designs are illustrated, it should be understood that various designs may be disposed between the end members and the cross members, including any of the other 32 NFL team logos, other sport team logos, company logos, or the like.

In the embodiment herein, a truck bed rack header comprises the following: a plurality of cross members extending generally horizontally; left and right end members interconnecting with left and right ends, respectively, of each of the plurality of cross members, wherein: the left and right end members form at least a portion of left and right sides of a front end of a truck bed rack assembly. The left and right end members include extension arms (i.e., protruding components) that telescopingly engage with each of the plurality of cross members; and the left and right end members are configured to be affixed to vertical rails at the front end of the truck bed rack assembly. The left and right end members form an entirety of the left and right sides of the front end of the truck bed rack assembly; and the left and right end members telescopingly fit into left and right-angle members, the left and right-angle members extending rearward from the left and right end members. Accordingly, the features of the truck bed rack header can permit the truck bed rack header to: fit into an existing rack, without any header; or create a rack where there is no existing rack assembly. The number of cross members in the plurality of cross members can vary.

Aspects of the present invention provide a truck headboard having an aesthetically pleasing design that can also be easily installed without requiring expensive fitment or design work. Further, the headboard can functionally protect a truck rear window with an easy-to-install system.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A truck bed rack header comprising:
a plurality of cross members extending in a horizontal direction; and
left and right end members positioned at left and right ends, respectively, of the plurality of cross members; and
mounting rails, wherein the mounting rails are L-shaped side rails having horizontal and vertical components;
wherein the plurality of cross members has a grate structure;
wherein the left and right end members form at least a portion of left and right sides of a front end of the truck bed rack header.

2. The truck bed rack header of claim 1, wherein the horizontal and vertical components of the mounting rails attach to sides of a truck bed.

3. The truck bed rack header of claim 1, wherein the mounting rails include receiving channels at forward ends thereof, and wherein the left and right end members are configured to fit into the receiving channels.

4. The truck bed rack header of claim 3, wherein the receiving channels extend inward from about 3 inches to about 12 inches in length.

5. The truck bed rack header of claim 1, wherein the left and right end members include extension arms that telescopingly engage with open ends of each of the plurality of cross members.

6. The truck bed rack header of claim 5, wherein the left and right end members are configured to attach to vertical risers of an existing truck rack system.

7. The truck bed rack header of claim 1, further comprising stanchions extending vertically between a bottom cross member and a top cross member of the plurality of cross members.

8. The truck bed rack header of claim 1, further comprising a decorative element displayable between the left and right end members and supported by the plurality of cross members.

9. The truck bed rack header of claim 8, wherein the decorative element comprises a circular surface configured to display team logos.

10. A truck bed rack header comprising:
a headboard frame including top and bottom horizontal frame members;
left and right end members interconnecting with ends of the top and bottom horizontal frame members to define the headboard frame;
a plurality of cross members spanning between the left and right end members within the headboard frame; and
stanchions contacting bottom edges of the internal spacers and configured to elevate the inner frame relative to an external edge;
wherein the plurality of cross members is thinner than the top and bottom horizontal frame members.

11. The truck bed rack header of claim 10, further comprising left and right side bars that incline inward toward the headboard frame.

12. The truck bed rack header of claim 11, further comprising vertical spacers extending upward from the headboard frame and contacting the left and right side bars.

13. The truck bed rack header of claim 11, further comprising internal spacers positioned between the left and right side bars and the headboard frame, wherein the internal spacers provide modifiable surfaces for engraving patterns.

14. The truck bed rack header of claim 13, wherein the internal spacers are operatively connected to each other via a bottom edge, and wherein the bottom edge, edges of the left and right internal spacers, and a body of the headboard frame define an inner frame.

15. The truck bed rack header of claim 14, further comprising a circular surface contained within the inner frame.

16. The truck bed rack header of claim 14, further comprising a cage pattern surrounding a circular surface within the inner frame.

17. The truck bed rack header of claim 14, wherein the external edge is an edge of a truck bed.

18. A truck bed rack header comprising:
a plurality of hollow cross members, each cross member having open channel ends;
left and right end members positioned at left and right sides of the truck bed rack header;
extending appendages protruding from the left and right end members, wherein the extending appendages are configured to engage with the open channel ends of the plurality of hollow cross members; and
L-shaped side rails having horizontal and vertical components;
wherein the left and right end members comprise hollow rectangular bars configured to receive the extending appendages through the open channel ends;
wherein the truck bed rack header is configured to retrofit into an existing truck rack system.

19. The truck bed rack header of claim 18, wherein each of the left and right end members includes three extending appendages forming an E-shape configuration.

20. The truck bed rack header of claim 18,
wherein the extending appendages are appended perpendicularly to external surfaces of the horizontal components.
